(19) United States
(12) Patent Application Publication
(10) Pub. No.: US 2009/0186190 A1
(43) Pub. Date: Jul. 23, 2009

(54) SILICON FILTER

(76) Inventors: Shan Guan, Dublin, OH (US); Michael F. Baumer, Dayton, OH (US); James A. Katerberg, Kettering, OH (US)

Correspondence Address: David A. Novais,;Patent Legal Staff,, Eastman Kodak Company, 343 State Street, Rochester, NY, 14650-2201, US

(21) Appl. No.: 12/015,540

(22) Filed: Jan. 17, 2008

(51) Int. Cl. B32B 3/10; B31D 3/00

(52) U.S. Cl. 428/137; 216/56

(57) ABSTRACT

The invention provides a filter device comprising a first member wherein at least a portion of the first member is foraminous, a second member wherein at least a portion of the second member is foraminous, wherein there is a fixed gap space between the members and wherein the holes of the first and second members are offset.

### FIELD OF THE INVENTION

The invention relates to a filter. The invention in its preferred embodiments relates to a filter that is utilized with inkjet print heads.

### BACKGROUND OF THE INVENTION

U.S. Pat. No. 5,124,717 to Campanelli et al discloses an inkjet print head with an integral membrane filter.

U.S. Pat. No. 5,204,690 to Lorenze Jr. discloses an inkjet print head having integral silicon filter produced by etching during printhead formation.

U.S. Pat. No. 6,877,964 to Burns et al, a two-layer filter, is disclosed wherein fluid is passed through opposing mesh layers by flexing the layers. The mesh layers may be offset by varying amounts.

U.S. Pat. No. 6,916,090 to Valley et al, discloses an integrated filter on a fluid ejection device. The device is used in an inkjet.

U.S. Pat. No. 6,450,619 to Anagnostopoulos et al discloses a method of fabricating nozzle plates, using CMOS and MEMS technologies which can be used in the above printhead. Further, in U.S. Pat. No. 6,663,221, issued to Anagnostopoulous et al, methods are disclosed of fabricating page wide nozzle plates, whereby page wide means nozzle plates that are about 4 inches long and longer. A nozzle plate, as defined here, consists of an array of nozzles and each nozzle has an exit orifice around which, and in close proximity, is a heater. Logic circuits addressing each heater and driver to provide current to the heater may be located in the same substrate as the heater or may external to it.

For a complete continuous inkjet printhead, besides the nozzle plate and its associated electronics, a means to deflect the selected droplets is required, and a gutter or catcher to collect the unselected droplets, an ink recirculation or disposal system, various air and ink filters, ink and air supply means and other mounting and aligning hardware are needed.

The US Publication 2006/0197819 A1 to Anagnostopoulos et al, disclosed an integral printhead member containing a row of inkjet orifices.

There remains a need for a filter that can be fabricated to reliably filter very small particles from a liquid in a reliable and stable manner. There is a particular need for a high quality filter that can be integral with a continuous inkjet printer.

### SUMMARY OF THE INVENTION

The invention provides a filter device comprising a first member wherein at least a portion of the first member is foraminous, wherein at least a portion of the second member is foraminous, wherein there is a fixed gap space between the members and wherein the holes of the first and second members are offset.

### BRIEF DESCRIPTION OF THE DRAWINGS

FIGS. 1-13 illustrate a preferred method of making a filter of the invention.

FIGS. 14 and 15 illustrate fabrication of a filter with pre-patterned gap layers.

FIGS. 16-22 illustrate an alternative method of forming the filter of the invention.

FIGS. 23 and 23A illustrate a stand-alone filter utilizing a filtering member of the invention.

FIGS. 24-27 illustrate an integral inkjet printhead utilizing a filter in accordance with the invention.

### DETAILED DESCRIPTION OF THE INVENTION

The invention has numerous advantages over prior practices in filtration. The invention finds use in the filtering of ink for inkjet printers. The filter of the invention may be formed integrally with the inkjet printer head thereby saving weight and providing effective filtering immediately prior to printing. The filter of the invention provides a stable filter that will provide uniform filtering of a liquid with removal of all particles below a certain size. The filter of the invention may be made to exact filter sizes as the process for manufacturing lends itself to formation of articles with micrometer accuracy, These and other advantages of the invention will be apparent from the following description and drawings.

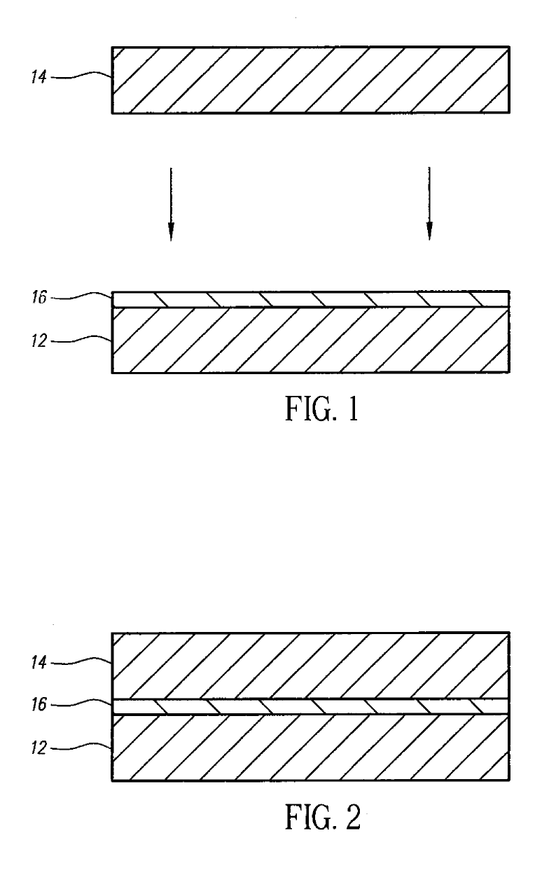

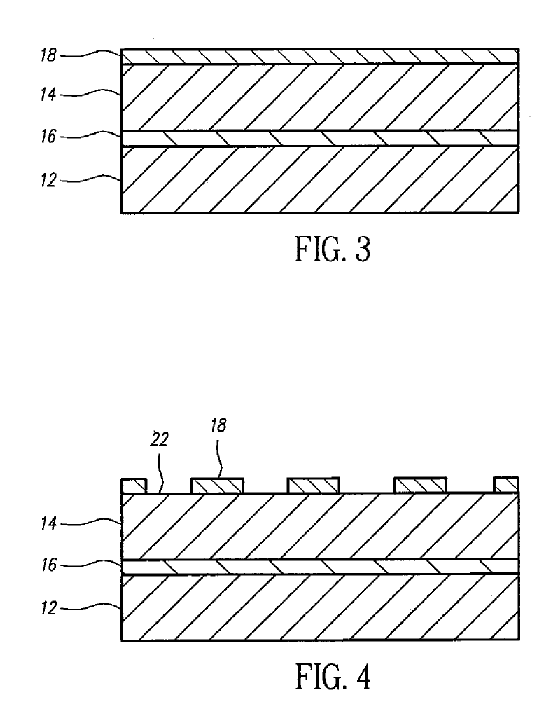

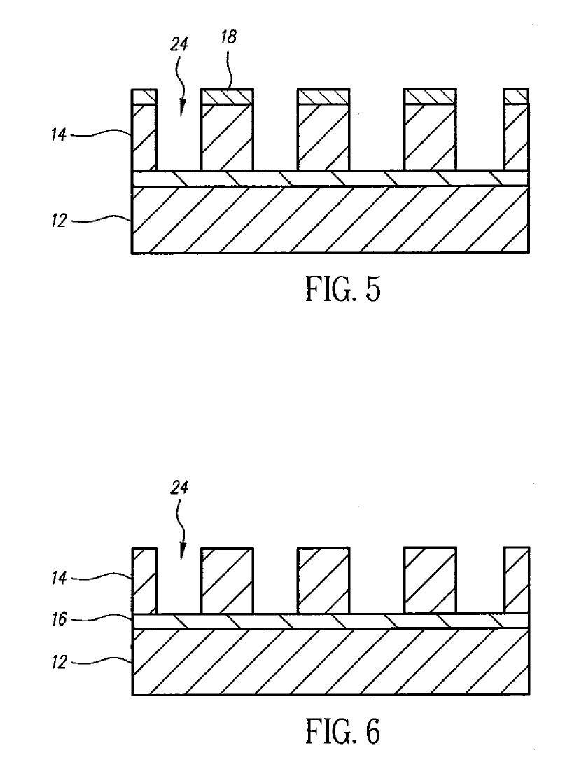

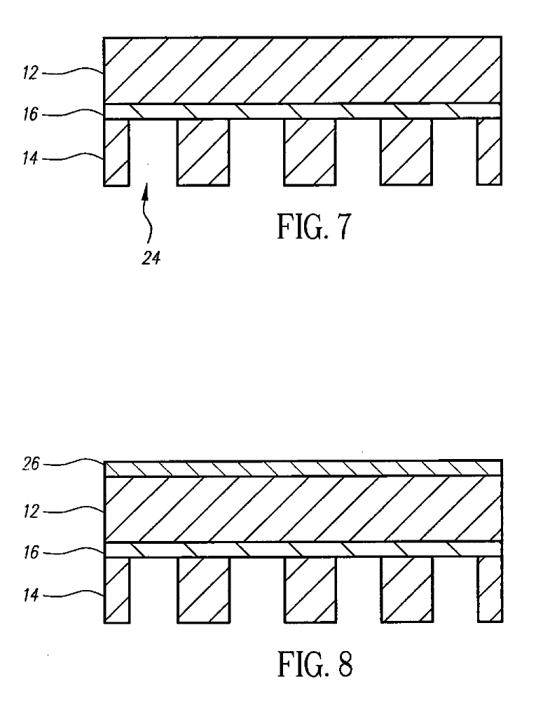

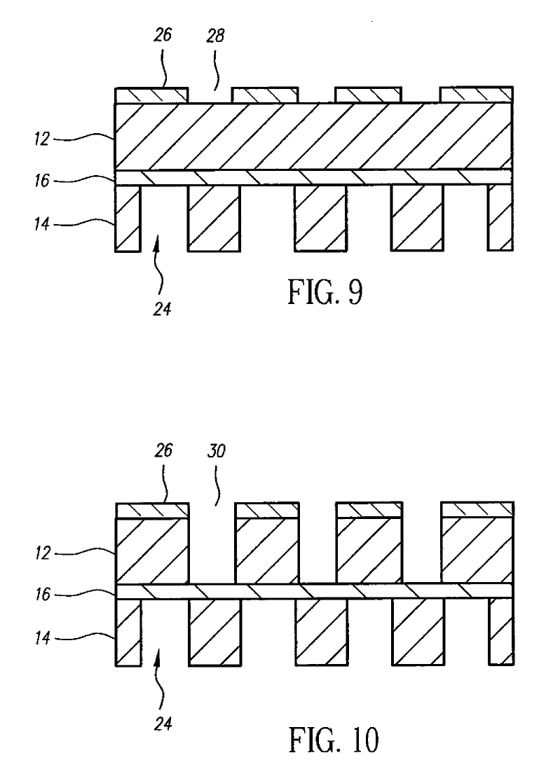

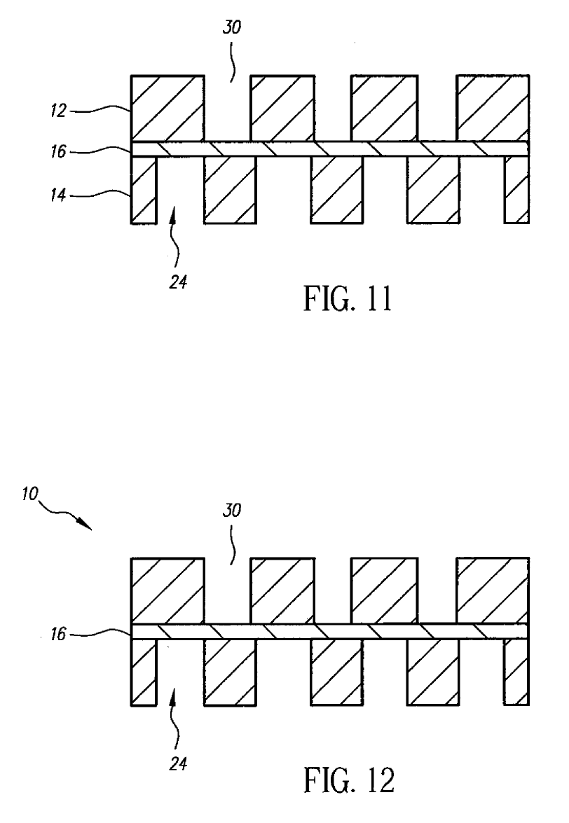

Shown in FIGS. 1-13 is the fabrication process for a filter in accordance with the invention. Shown in FIG. 1 are planar silicon wafers. A first silicon wafer member 12 has grown a layer 16 of thermal silicon dioxide of between 1 and 2 μm in thickness. The thickness of the layer will determine the particle size of the particle that may be blocked by the filter. Second member 14 is a silicon wafer that will be diffusion bounded to member 12. The wafers forming first member 12 and second member 14 may be of any suitable thickness. A preferred thickness is between 100 and 200 micrometers for sufficient strength and rigidity. A suitable thickness may be between fifty and one thousand micrometers. The silicon dioxide layer 16, referred to as the gap layer, has a possible thickness of between 50 nm and 4000 nm. The preferred thickness is between about 1 and 2 μm for the filtering of ink. First member 14 and second member 12 are adhered together by diffusion bonding of the second member 14 to the silicon dioxide layer 16. FIG. 2 is a cross-section of the bonded members with first and second member 12 and 14 respectively with a gap layer 16. FIG. 3 illustrates the bonded layers further provided with a photoresist layer 18. The photoresist layer may be formed by several techniques such as spin coating. A positive or negative photoresist may be utilized. As illustrated in FIG. 4 the photoresist has been removed in areas 22 by photolithography to form the etching mask for channels to be formed in FIG. 5. In FIG. 5 member 14 has been etched to form holes or foramini 24 into the silicon using the deep reactive ion etching (DRIE) technique. The etching will be stopped when it reaches the buried silicon dioxide layer because DRIE etching is around 100 times as effective on silicon as it is on silicon dioxide. In FIG. 6 the etched member 14 of FIG. 5 is shown with the photoresist layer 18 removed. The photoresist is typically removed using acetone or other organic solvent. The surfaces then may be cleaned with oxygen plasma. In FIG. 7 the partially formed filter has been flipped over to work on member 12. In FIG. 8 a layer of photoresist 26 has been placed on the exposed surface of first member 12. In FIG. 9 etching has removed photoresist exposing areas 28 in layer 26. In FIG. 10 holes or foramina 30 have been etched on exposed areas 20 of member 12. As stated above the DRIE etching is not effective for etching silicon dioxide and therefore the creation of holes 30 ends at the silicon dioxide gap layer. In FIG. 11 the filter is shown after treatment to remove the photoresist layer 26. It is noted that at this stage the silicon dioxide layer is continuous and therefore a filter is not formed.

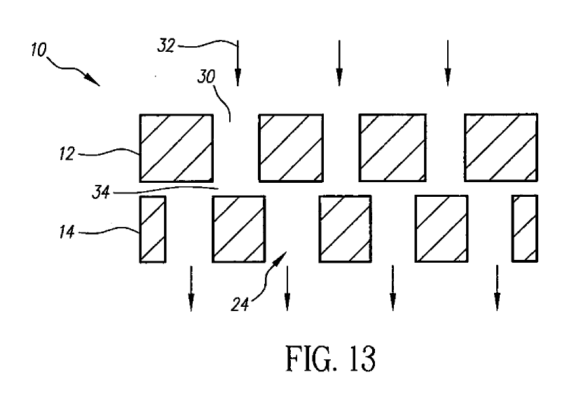

FIG. 12 shows a filter 10 with portions of the silicon dioxide removed adjacent to the holes. The silicon dioxide is removed by wet etching or dry etching to form the open gap adjacent holes 30 and 24. Oxide is removed by material such as buffered hydrofluoric acid or plasma etching. Plasma etching utilizing a process such as reactive ion etching (RIE) is preferred as the process is a clean process and easier to control than using wet etching. While the silicon dioxide gap layer must be removed from between the first member and the second member in the region of the holes through these members, it must remain in place between the first and second members in other regions such as around the perimeter of the filter. By removing the gap layer in the region of the holes through the first and second member and retaining the gap layer in other regions, the first and second members remain fixedly attached to each other with a well defined fixed gap space between them in the region of the holes through the first and second layers. FIG. 13 shows the mechanism of utilizing the filter with a fluid represented by arrows 32 entering holes 30 and exiting holes 24. The size of particle removed by the filter is determined by the spacing 34, the thickness of the gap layer. It is noted that the holes 30 and 24 are offset such that the ink can not directly travel from a hole in the first member 12 to a hole in the second member 14.

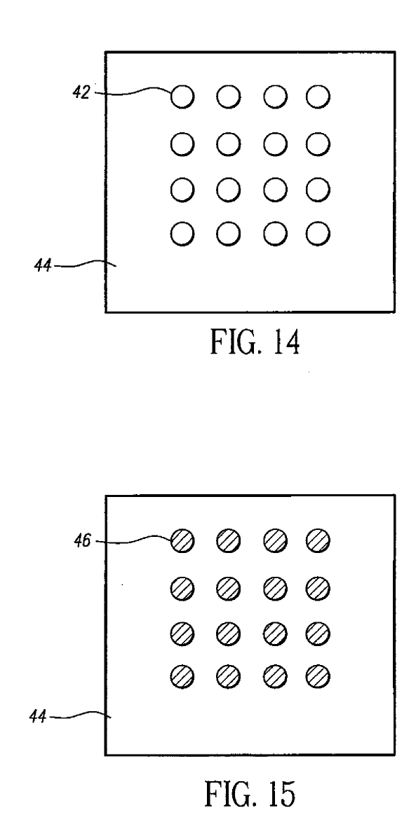

In another embodiment of the invention, there are provided posts in the area of the gap layer to add strength to the filter. The addition of posts is helpful in those instances where the first member and/or the second member is relatively thin and the number of holes in the filter is large. FIG. 14 is a top view of the gap layer on a member to be formed into a filter. The gap layer has been partially removed to form holes thereby forming a foraminous area 42 in the gap layer 44. FIG. 15 shows the holes in the gap layer 44 have been filled with silicon nitride 46. When this gap layer has a second member bonded to it and then the filter formed as illustrated in FIGS. 1-13 the silicon nitride posts will not be removed by the process of removing the gap layer. The silicon nitride posts will remain to strengthen the filter. If an appropriate mask is used for the creation of such posts, one can form defined flow channels between the holes in the first member and holes in the second member. Defined flow channels formed in this manner can make the filter more effective in filtering out flake-like particles whose thickness is less than the height of the gap.

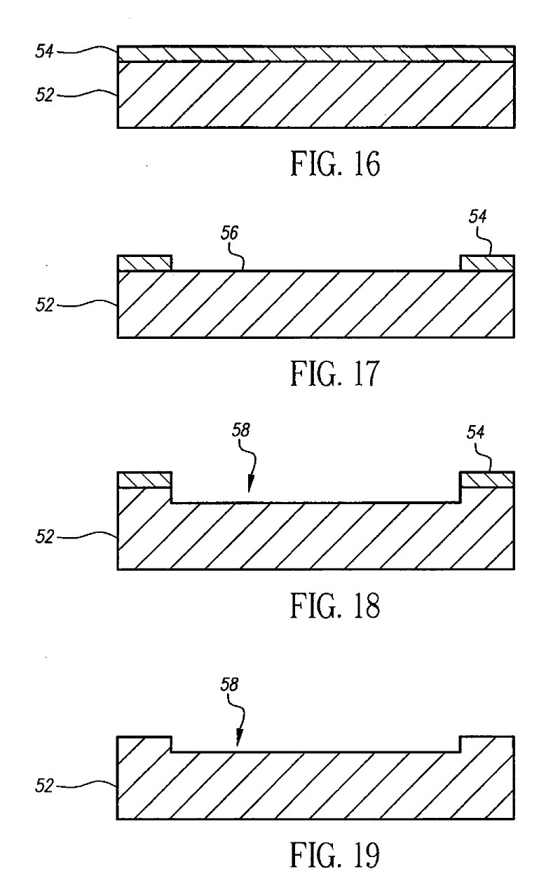

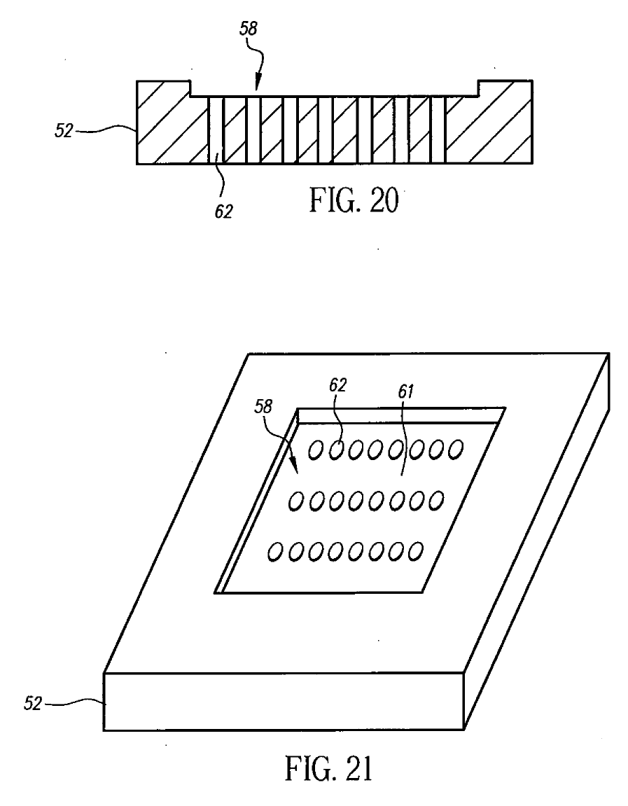

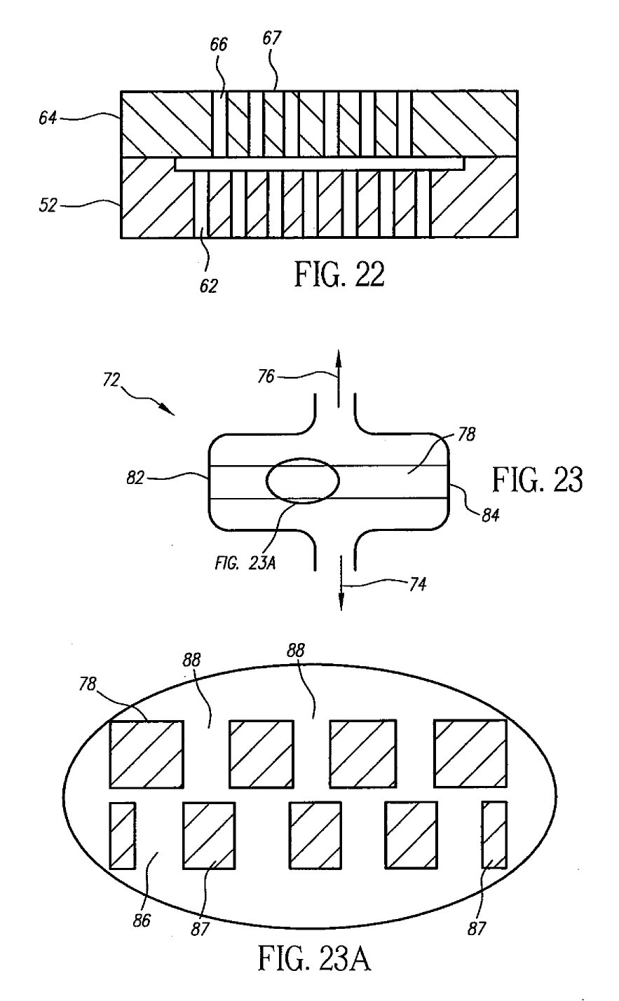

FIGS. 16-23 illustrate another filter forming technique to form a filter in accordance with the invention. This embodiment does not require the utilization of a gap layer in the formation of the filter. In this embodiment the two silicon wafers are bonded directly together after they have been subjected to an etching process such as DRIE. FIG. 16 shows a first member 52 and a photoresist layer 54. In FIG. 17 the photoresist layer 54 has been removed within area 56. FIG. 18 illustrates the first number 52 after etching has removed a portion of the silicon to form the U-shaped opening 58. In FIG. 19 the photoresist material has been removed. FIG. 20 illustrates the first member after having holes 62 etched through the member 52 and the U-shaped opening 58. The etching is carried out using the photoresist method as earlier described. FIG. 21 is a perspective view of the first member 52 having U-shaped opening 58 that has been provided with holes forming a foraminous area 61. In FIG. 22 a second member 64 has been joined with first member 52. Second member 64 has been formed by the same DRIE process as illustrated above. The second member 64 has a rectangular cross-section. The second member 64 has been provided with holes 66 forming a foraminous area 67. The holes 66 are offset from the holes 62 in the first member. It is noted that in all drawings of this invention the size of the foramini or holes and the height of the gap between the upper and lower member is larger than would be present if the drawings were to scale. This embodiment of FIG. 22 does not require the gap layer, however, it does require accurate placement of the silicon wafer members 52 and 64 as the holes must be offset.

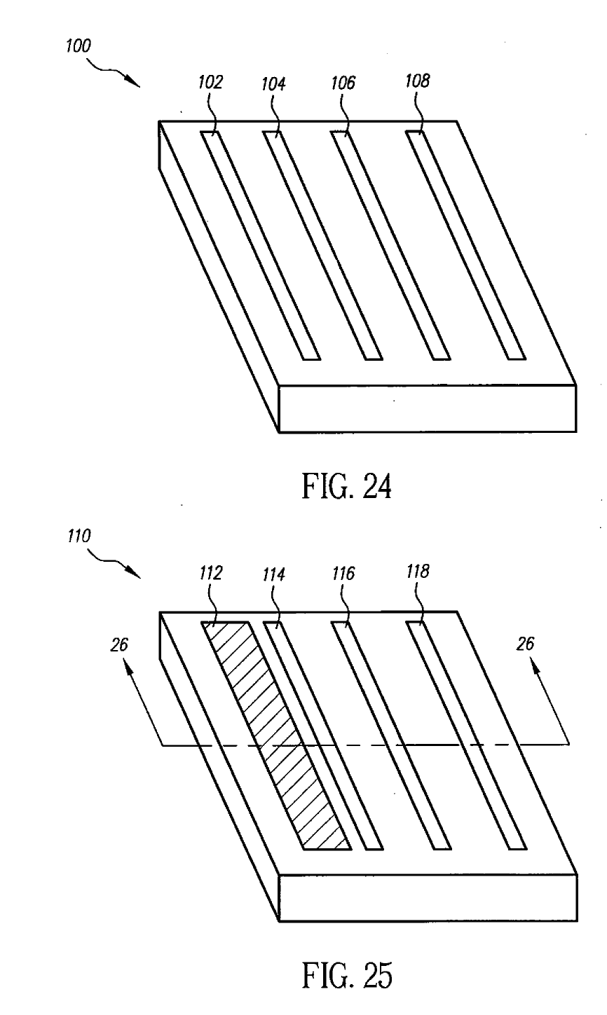

In FIGS. 23 and 23A there is illustrated a filter utilizing the filter element of the invention. Shown in FIG. 24 is filter 72. In filter 72 the fluid enters at 74 and flows out at 76. The filter element 78 is fastened to walls 82 and 84 in a liquid tight manner such that fluids will go through the filter 78. FIG. 24A is an enlarged portion of filter element 78 in the filter 72. The holes 86 and 88 of filter 78 element are of different sizes. The holes 86 in the inlet side have a larger cross-section than those holes 88 in the outlet area. This allows the filter to be more easily cleaned by back flushing of fluid such that the particles trapped by the filter wash out of the larger holes 86.

FIG. 24 shows a perspective view of an inkjet head 100. The view is from the inlet side. The head contains nozzles on the outlet side (not shown) and slots 102, 104, 106, and 108 on the upper side. The slots are for supplying ink 102, supplying droplet stream control air 104, removing droplet control air 106, and withdrawing unused ink from the inkjet head 108. The integral inkjet head is preferably made out of silicon.

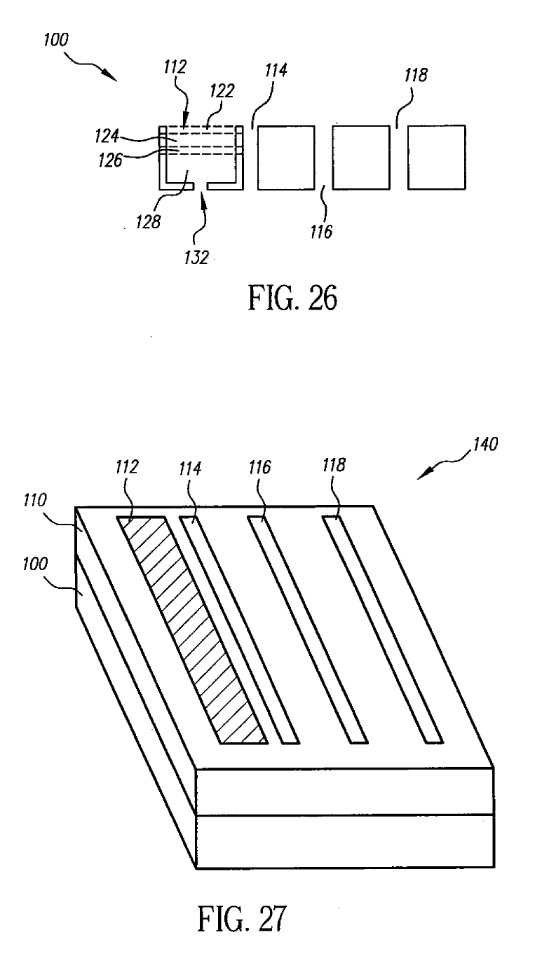

Shown in FIGS. 25 and 26 is an integral filter member 110 containing the filter 112 for mounting so as to become integral with the inkjet head 100. FIG. 26 is a cross-section on line 27-27 in FIG. 25. The filter 112 is comprised of the outer foraminous member 122, inner foraminous member 126, and the space (gap) 124 between the foraminous members 122 and 126. The inner foraminous member 126 is adjacent a sump 128 from which the ink is removed at exit opening 132 to enter the printhead 100.

In FIG. 27 the integral filter member 110 and has been adhered to the inkjet 100. The openings of 114, 116, and 118 in the filter member 110 correspond to and are aligned respectively with the openings 104, 106, and 108 in the inkjet head 100 when the filter member 110 and the inkjet head 100 are joined. The outlet 132 from the sump 128 of the filter 112 and the opening 102 in the inkjet head also are aligned.

In the filters in accordance with the invention the holes may be offset by any amount that is effective in forming the filter. Generally with filters for ink the holes would be offset by a distance of between 10 and 30 μm for effective filtering and to provide a strong filter. A distance of offset must be such that there is no direct movement between the holes in a first foraminous member directly into the holes in another second foraminous member of the filter without passing horizontally in the gap from a hole in the first member to a hole in the second member. The size of hole may be any suitable size. A preferred size for use with inkjet inks is between 10 and 15 μm to prevent clogging of inkjet orifice holes. The hole may be any cross-section shape including square or oval. However, generally round holes are preferred as they are easier to make.

The thickness or height of the gap is less than the diameter of the holes in both foraminous members in the preferred filter, but should be less in at least one of the foraminous members. Generally for an inkjet filter the gap between the foraminous members would be between 1 and 2 μm for effective filtering of particles that would clog the inkjet orifice.

The filters when utilized with an inkjet ink generally operate at an input pressure of between 60 and 100 psi. It is preferred that the pressure drop be between 10 and 30 psi as ink passes to the filter. The filters may be utilized with either continuous or intermittent inkjet printers. The invention filters find best use in a continuous inkjet due to the large amount of ink passing through the printer but would also be suitable for drop on demand printers. The filters are suitable both with inks that contain dyes and inks with pigment.

The techniques for creation of silicon materials involving etching several silicon wafers which are then united in an extremely accurate manner is particularly desirable for formation of the foraminous member as the distance between the foraminous members of the filters must be accurately controlled. Further, there is need to put channels for fluid and air handling into the silicon structure in an accurate manner.

The filter device of the invention may be formed by any of the known techniques for shaping silicon articles. These include CMOS circuit fabrication techniques, microelectrical mechanical structure fabrication techniques (MEMS) and others. The preferred technique has been found to be the deep reactive ion etch (DRIE) process. Because this process enables fabrication of high aspect ration structures with large etch depths deep (>10 micrometers) required for this device in comparison with other silicon formation techniques.

Materials used for the foraminous members forming the filter may be selected from any suitable material. Semiconductor material such as silicon, gallium arsenide; dielectric materials such as aluminum oxide, silicon nitride, silicon dioxide, silicon carbine and titanium nitride are suitable. Metal films such as the films deposited by physical vapor deposition, electroplating, or electroless plating are also suitable. Plastic materials such as epoxy and polyimide are also suitable. A preferred material is silicon as a single crystal, polysilicon or amorphous silicon because it may be formed to close tolerances and is resistant to wear. Materials of the two foraminous layers may be the same or different, but fabrication is generally easier if the same material is used in both foraminous layers.

The gap layer may be formed of silicon dioxide, silicon nitride, poly silicone, single crystal silicon, amorphous silicon or other material patternable by microfabrication techniques. Silicon dioxide is preferred for its ease of use in combination with silicon and its low cost. When the hole patterns in the first member and the second member are formed by an etching process, it is desirable to select the gap layer material such that is not etched by or more slowly etched by the etchant used to make the hole patterns than the materials of the first and second members. A means, such as an alternate etchant, can then be used to preferentially remove portions of the gap layer without affecting the first and second members.

PARTS LIST

| | |
|---|---|
| 12 | First member |
| 14 | Second member |
| 16 | Gap layer |
| 18 | Photoresist layer |
| 20 | Area |
| 22 | Area |
| 24 | Holes (foramina) |
| 26 | Photoresist Layer |
| 28 | Area |
| 30 | Holes (foramina) |
| 32 | Arrow |
| 34 | Spacing |
| 42 | Foraminous area |
| 44 | Gap layer |
| 46 | Silicon Nitride |
| 52 | First member |
| 54 | Photoresist Layer |
| 56 | Area |
| 58 | Opening |
| 61 | Area (foraminous) |
| 62 | Holes |
| 64 | Second member |
| 66 | Holes |
| 67 | Area (foraminous) |
| 72 | Filter |
| 74 | Fluid |
| 78 | Filter element |
| 82 | Walls |
| 84 | Walls |
| 86 | Holes |
| 88 | Holes |
| 100 | Inkjet head |
| 102 | Slot |
| 104 | Slot |
| 106 | Slot |
| 108 | Slot |
| 110 | Filter member |
| 112 | Filter |
| 114 | Opening |
| 116 | Opening |
| 118 | Opening |
| 122 | Foraminous member |
| 124 | Space |
| 126 | Foraminous member |
| 128 | Sump |
| 132 | Opening |

1. A filter device for removing particles from a fluid, the filter device comprising:
a first member at least a portion of which is foraminous so as to have small holes;
a second member at least a portion of which is foraminous so as to have small holes; and
a fixed gap space between the first and second members which allows the fluid to flow across the fixed pap space from holes of the first member at the fixed gap space directly to holes of the second member at the fixed gap space,
wherein each one of the holes of the first member at the fixed gap space is offset from each one of the holes of the second member at the fixed gap space so that the fluid cannot flow across the fixed gap space from every one of the holes of the first member at the fixed gap space directly to everyone of the holes of the second member at the fixed gap space without shifting laterally in the fixed gap space.

2. The filter device of claim 1 wherein said filter device further comprises a fixed gap layer between said first member and second member in the non-foraminous area of the filter and the fixed gap space is between said first member and second member in the non-foraminous area of the filter.

3. The filter device of claim 1 wherein the fixed gap space is a space between said first and second members that is less than the diameter of the individual foramini of said first member and said second member in order to determine the size of particles removed from the fluid.

4. (canceled)

5. The filter device of claim 3 wherein the height of the gap space between the first member and the second member determines the size particle that will pass through the filter.

6. (canceled)

7. The filter device of claim 1 wherein the space between said first member and said second member is between 1 and 2 micrometers.

8. The filter device of claim 1 wherein the diameter of the holes of the first and second foraminous member are between 10 and 15 micrometers.

9. The filter device of claim 1 wherein the offset is between 10 and 30 micrometers.

10. The filter device of claim 1 wherein the holes of one of the first member and the second member are larger.

11. The filter device of claim 1 wherein said device is designed to operate at a pressure of between 60 and 100 pounds per square inch.

12. The filter device of claim 1 wherein at least one of the first member and the second member is reduced in thickness in the foraminous area of the member.

13. The filter device of claim 12 wherein the first member and a second member are adhered together such that the at least one reduced thickness area forms the gap space between the first member and the second member.

14. (canceled)

15. The filter of claim 1 wherein the first member and the second member comprise silicon wafers having thickness of between 50 and 1000 micrometers.

16. A method for fabrication of a filter comprising providing a first member, a second member, and a gap layer on said first layer, etching said first member to create a pattern of holes through said first member, attaching said second member to said gap layer, etching the second member to create a pattern of holes, removing at least a portion of the gap layer between the pattern of holes in said first member and the pattern of holes in the second member, wherein no holes in said first member are aligned with holes in the second layer and the gap between the layers is less than the diameter of the holes.

17. The method of claim 16, wherein said first member and second member are planar silicon members having a thickness of between 50 and 1,000 micrometers.

18. The method of claim 16, wherein said gap layer is between one and two micrometers thick.

19. The method of claim 17, wherein creation of the holes is carried out by deep reactive ion etching.

20. The method of claim 19, wherein the gap layer comprises silicon dioxide.

21. The method of claim 20, wherein the gap layer removal is by reactive ion etching.

22. The method of claim 16, wherein the hole diameter is between ten and fifteen micrometers.
